(19) United States
(12) Patent Application Publication
(10) Pub. No.: US 2026/0006663 A1
(43) Pub. Date: Jan. 1, 2026

(54) COMMUNICATION DEVICE, TERMINAL DEVICE, AND NON-TRANSITORY COMPUTER-READABLE RECORDING MEDIA STORING COMPUTER-READABLE INSTRUCTIONS FOR COMMUNICATION DEVICE AND TERMINAL DEVICE

(71) Applicant: BROTHER KOGYO KABUSHIKI KAISHA, Nagoya (JP)

(72) Inventor: Takeshi MIYAKE, Nagoya (JP)

(21) Appl. No.: 19/250,176

(22) Filed: Jun. 26, 2025

(30) Foreign Application Priority Data
Jun. 28, 2024 (JP) 2024-105163

(51) Int. Cl. H04W 76/15; H04L 43/0811; H04W 84/12

(52) U.S. Cl. CPC H04W 76/15; H04L 43/0811; H04W 84/12

(57) ABSTRACT

A communication device may be configured to: establish a first wireless connection between the communication device and a first external device according to a first scheme, wherein the communication device is able to execute wireless communication with a terminal device by using the first wireless connection; establish a second wireless connection between the communication device and the terminal device according to a second scheme; and in a case where the communication device shifts to a state in which the communication device is unable to execute wireless communication with the terminal device by using the first wireless connection after both the first wireless connection and the second wireless connection have been established at the communication device, send disablement information to the terminal device by using the second wireless connection, wherein the disablement information indicates that the wireless communication using the first wireless connection is inexecutable.

### REFERENCE TO RELATED APPLICATION

This application claims priority to Japanese Patent Application No. 2024-105163 filed on Jun. 28, 2024. The entire content of the priority application is incorporated herein by reference.

### BACKGROUND ART

A technology is known that notifies a user of a cause of communication being inexecutable between a communication device and an information processing device via an external device. According to this technology, when communication is inexecutable via the external device, a connection is newly established between the communication device and the information processing device without intervention of the external device. The information processing device then acquires the cause from the communication device via the newly established connection and notifies the user of the cause.

### SUMMARY

The disclosure herein provides a novel technology for notifying a user that a communication device is unable to execute wireless communication.

A communication device is disclosed herein. The communication device may include a Wi-Fi interface configured for wireless communication according to Wi-Fi standard and a controller. The controller may be configured to establish a first wireless connection between the communication device and a first external device via the Wi-Fi interface according to a first scheme of the Wi-Fi standard, wherein the communication device is able to execute wireless communication with a terminal device by using the first wireless connection. The controller may be configured to establish a second wireless connection between the communication device and the terminal device via the Wi-Fi interface according to a second scheme of the Wi-Fi standard different from the first scheme. The controller may be configured to, in a case where the communication device shifts to a state in which the communication device is unable to execute wireless communication with the terminal device by using the first wireless connection after both the first wireless connection and the second wireless connection have been established at the communication device, send disablement information to the terminal device via the Wi-Fi interface by using the second wireless connection, wherein the disablement information indicates that the wireless communication using the first wireless connection is inexecutable.

According to the configuration above, in the case where the communication device shifts to the state in which the communication device is unable to execute wireless communication with the terminal device by using the first wireless connection after the first wireless connection according to the first scheme and the second wireless connection according to the second scheme have been established, the communication device sends the disablement information to the terminal device by using the second wireless connection. Thus, a user of the terminal device is notified that the communication device is unable to execute wireless communication using the first wireless connection.

A terminal device is also disclosed herein. The terminal device may include a Wi-Fi interface configured for wireless communication according to Wi-Fi standard and a controller. The controller may be configured to establish a first wireless connection between the terminal device and a first external device via the Wi-Fi interface according to a first scheme of the Wi-Fi standard, wherein the terminal device is able to execute wireless communication with a communication device by using the first wireless connection. The controller may be configured to establish a second wireless connection between the communication device and the terminal device via the Wi-Fi interface according to a second scheme of the Wi-Fi standard different from the first scheme. The controller may be configured to, in a case where the communication device shifts to a state in which the communication device is unable to execute wireless communication with the terminal device by using the first wireless connection after both the first wireless connection and the second wireless connection have been established at the terminal device, receive disablement information from the communication device via the Wi-Fi interface by using the second wireless connection, wherein the disablement information indicates that the wireless communication using the first wireless connection is inexecutable. The controller may be configured to, in a case where the disablement information is received from the communication device, cause an output unit of the terminal device to output the disablement information.

According to the configuration above, in the case where the communication device shifts to the state in which the communication device is unable to execute wireless communication with the terminal device by using the first wireless connection after the first wireless connection according to the first scheme and the second wireless connection according to the second scheme have been established, the terminal device receives the disablement information from the communication device by using the second wireless connection and outputs the disablement information. Thus, the user of the terminal device is notified that the communication device is unable to execute wireless communication by using the first wireless connection.

Computer-readable instructions (i.e., computer program) for the above communication device, a non-transitory computer-readable recording medium storing the computer-readable instructions, and methods performed by the communication device are also novel and useful. Further, computer-readable instructions (i.e., computer program) for the above terminal device, a non-transitory computer-readable recording medium storing the computer-readable instructions, and methods performed by the terminal device are also novel and useful. Additionally, communication systems comprising the above communication device and terminal device are also novel and useful.

### BRIEF DESCRIPTION OF DRAWINGS

FIG. 1 is a diagram illustrating a configuration of a communication system.

FIG. 2 is a sequence diagram of actions performed by each device.

FIG. 3 is a sequence diagram according to a first embodiment.

FIG. 4 is a sequence diagram according to a second embodiment.

FIG. 5 is a sequence diagram according to a third embodiment.

FIG. 6 is a sequence diagram according to a fourth embodiment.

### DESCRIPTION

### First Embodiment

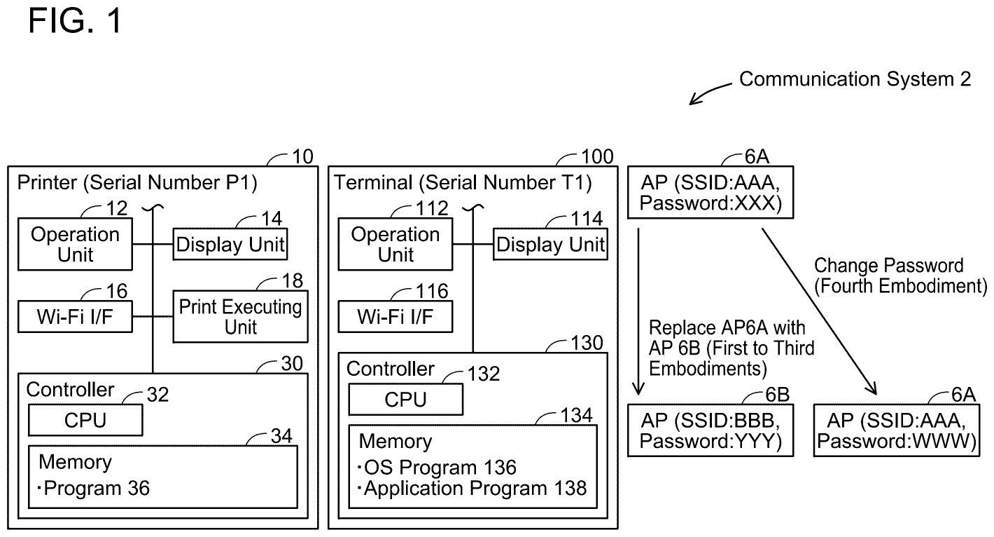

### Configuration of Communication System 2: FIG. 1

As shown in FIG. 1, a communication system 2 comprises a printer 10, a terminal 100, and an access point (“AP” hereinafter) 6A. A wireless connection according to a Wi-Fi Aware scheme of the Wi-Fi standard (termed “Wi-Fi Aware connection” hereinafter) is established between the printer 10 and the terminal 100. The printer 10 and the terminal 100 belong to a wireless network formed by the AP 6A. For example, the terminal 100 receives a status of the printer 10 by using the Wi-Fi Aware connection and sends print data representing an image to be printed (termed “print target image” hereinafter) to the printer 10 via the AP 6A, although details will be described later. This embodiment assumes that the printer 10 and the terminal 100 becomes unable to wirelessly communicate with each other via the AP 6A due to the AP 6A being replaced with an AP 6B.

### Configuration of Printer 10

The printer 10 is a peripheral device configured to execute a print function, for example, a peripheral device of the terminal 100. In a modification, the printer 10 may be a multifunctional device configured to execute a scan function, a facsimile function, and the like in addition to a print function. The printer 10 comprises an operation unit 12, a display unit 14, a Wi-Fi interface 16, a print executing unit 18, and a controller 30. The units 12 to 30 are connected to a bus line. Hereinafter, an interface is abbreviated as “I/F”.

The operation unit 12 is an I/F configured to allow a user to input various information to the printer 10 and comprises, for example, a touch screen and/or buttons. The user can input various information to the printer 10 via the operation unit 12. The display unit 14 is a display for displaying various information. The print executing unit 18 comprises a print mechanism of, for example, inkjet scheme, laser scheme, or thermal scheme.

The Wi-Fi I/F 16 is a wireless I/F for Wi-Fi communication according to the Wi-Fi standard. The Wi-Fi standard is a wireless communication standard for wireless communication according to, for example, 802.11 standard of the Institute of Electrical and Electronics Engineers, Inc. (IEEE) and standards in compliance therewith such as 802.11a, 11b, 11g, 11n, and 11ac. Especially, the Wi-Fi I/F 16 supports the Wi-Fi Aware scheme established by the Wi-Fi Alliance. The Wi-Fi Aware scheme is described in detail in the specification called “Wi-Fi Aware Specification Version 4.0” created by the Wi-Fi Alliance. Wi-Fi Aware is also called Wi-Fi Neighbor Awareness Network (NAN).

The devices (the printer 10 and the terminal 100) can join a NAN cluster of the Wi-Fi Aware scheme, although details will be described later. Among devices within the same NAN cluster, their Discovery Windows are synchronized. Here, a Discovery Window is a period during which signals are communicated.

Each of the devices within the NAN cluster plays any one of the following roles: a Master, an Anchor Master, and a Non-Master. A Master is capable of sharing timer information, searching for services, and inviting device(s) to the NAN cluster. In addition to the Master's functions, an Anchor Master is also capable of setting timer information for synchronization. A Non-Master is capable of sharing timer information and searching for services but incapable of inviting device(s) to the cluster.

Each device within the NAN cluster can search for another device (more specifically, a service provided by another device) within the NAN cluster. A signal for this service search is called Subscribe. A device sends a response signal called Publish in response to receiving a Subscribe. In this embodiment, the terminal 100 sends a Subscribe to search for a device that can provide a connection service related to Wi-Fi Aware connection, although details will be described later. The printer 10 can provide the connection service and thus sends the terminal 100 a Publish indicating that the printer 10 provides the connection service. After this, upon the completion of a paring process to establish a Wi-Fi Aware connection between the printer 10 and the terminal 100, a Wi-Fi Aware connection is established between the printer 10 and the terminal 100. In this embodiment, the terminal 100 also sends a Subscribe to search for a device that can provide a status service related to device status. The printer 10 can provide the status service and thus sends a Publish including its own status (e.g., connection status) to the terminal 100.

The Wi-Fi I/F 16 is also a wireless I/F for wireless communication according to a normal W-Fi scheme of the Wi-Fi standard, which is different from the Wi-Fi Aware scheme. Generally, wireless communication according to the normal Wi-Fi scheme refers to wireless communication using an AP (e.g., the AP 6A), while wireless communication according to the Wi-Fi Aware scheme refers to wireless communication without the use of an AP. For example, the printer 10 can join a normal W-Fi network by establishing a wireless connection with an AP (e.g., 6A) (termed “AP connection” hereinafter). The printer 10 can execute wireless communication with devices (e.g., the terminal 100) within the normal W-Fi network via the AP.

The controller 30 comprises a CPU 32 and a memory 34. The memory 34 comprises a main storage and an auxiliary storage. The main storage comprises, for example, a RAM, cache memory, etc. The auxiliary storage may be, for example, a flash memory, a solid state drive (SSD), a ROM, or any combination thereof. A program 36 is stored in the auxiliary storage. The CPU 32 implements various processes according to the program 36 loaded from the auxiliary storage to the main storage.

### Configuration of Terminal 100

The terminal 100 is a mobile terminal device such as a mobile phone, a smartphone, a PDA, a tablet PC, or the like. In a modification, the terminal 100 may be a stationary PC, a laptop PC, or the like. The terminal 100 comprises an operation unit 112, a display unit 114, a Wi-Fi I/F 116, and a controller 130. The units 112 to 130 are connected to a bus line.

The operation unit 112 is an I/F configured to allow the user to input various information to the terminal 100 and comprises, for example, a touch screen and/or buttons. The user can input various information to the terminal 100 via the operation unit 112. The display unit 114 is a display for displaying various information. The Wi-Fi I/F 116 is the same as the Wi-Fi I/F 16 of the printer 10. That is, the Wi-Fi I/F 116 supports the Wi-Fi Aware scheme.

The controller 130 comprises a CPU 132 and a memory 134. The memory 134 comprises a main storage and an auxiliary storage. The main storage comprises, for example, a RAM, a cache memory, etc. The auxiliary storage may be, for example, a flash memory, a Solid State Drive (SSD), a ROM, or any combination thereof. An OS program 136 and an application program 138 are stored in the auxiliary storage. The CPU 132 implements various processes according to the programs 136, 138 loaded from the auxiliary storage to the main storage. Hereinafter, the OS program is abbreviated as “OS” and the application program is abbreviated as “app”.

The OS 136 controls basic operations of the terminal 100. The app 138 can cause the OS 136 to execute a process according to the Wi-Fi Aware scheme to establish a Wi-Fi Aware connection between the printer 10 and the terminal 100. The app 138 can also send print data representing a print target image to the printer 10 via an AP (e.g., the AP 6A). The app 138 is downloaded, for example, from a server on the internet and installed in the terminal 100.

### Configuration of AP 6A

The AP 6A is a normal access point called a wireless access point or a wireless LAN router. The AP 6A relays communication between a pair of devices that belong to a wireless network in which the AP 6A operates as the parent station. The AP 6A stores a service set identifier (SSID) “AAA” and a password “XXX”. Hereinafter, a password is abbreviated as “PW”. The SSID “AAA” is information for identifying the wireless network formed by the AP 6A. The PW “XXX” is authentication information used in the wireless network.

### Configuration of AP 6B

An AP 6B stores an SSID “BBB” and a PW “YYY”. Except for this, the AP 6B is the same as the AP 6A.

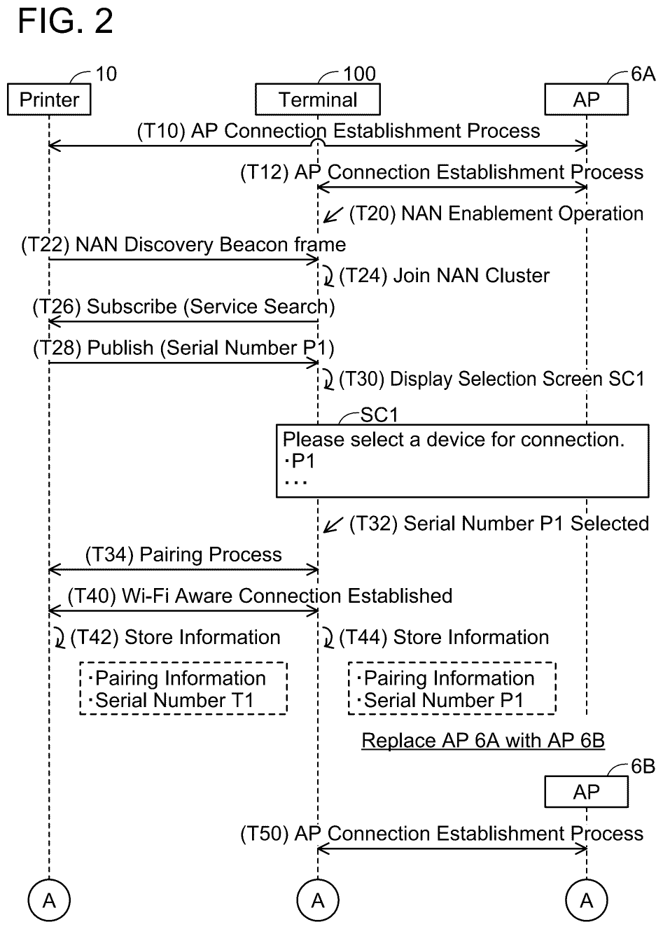

### Steps Between Devices: FIG. 2

Referring now to FIG. 2, steps performed between the devices are described. Hereinafter, in order to facilitate understanding, steps performed by the CPUs (e.g., 32, 132) of the devices (e.g., the printer 10, the terminal 100) are described as if the devices perform the steps, instead of describing that the CPUs perform the steps. Every communication between the devices is executed via the Wi-Fi I/Fs (e.g., 16, 116). Thus, hereinafter, a phrase “via the Wi-Fi interface” is omitted in communication-related description. In the initial state in FIG. 2, the printer 10 is operating as an Anchor Master in a NAN cluster.

In T10, a process for establishing an AP connection between the printer 10 and the AP 6A is executed, and as a result, an AP connection is established between the printer 10 and the AP 6A. The above process includes, for example, input of the SSID “AAA” and the PW “XXX” into the printer 10, authentication of the input SSID “AAA” and PW “XXX”, etc. When the AP connection is established with the AP 6A in T10, the printer 10 stores the SSID “AAA”, although this is not illustrated.

In T12, a process for establishing an AP connection between the terminal 100 and the AP 6A is executed, and as a result, an AP connection is established between the terminal 100 and the AP 6A. Consequently, both the printer 10 and the terminal 100 belong to the wireless network formed by the AP 6A. That is, the printer 10 and the terminal 100 are communicable with each other via the AP 6A. When the AP connection is established with the AP 6A in T12, the terminal 100 stores the SSID “AAA”, although this is not illustrated.

In T20, the terminal 100 receives a NAN enablement operation from the user and in response to it, the terminal 100 shifts to a state of being able to receive signals according to the Wi-Fi Aware scheme. Here, the “state of being able to receive signals according to the Wi-Fi Aware scheme” means that the Wi-Fi I/F 116 can receive signals according to the Wi-Fi Aware scheme from external devices and the CPU 132 can perform steps according to the received signals.

In T22, the printer 10 sends a NAN Discovery Beacon frame (termed “Discovery” hereinafter) by broadcasting. The Discovery is a signal according to the Wi-Fi Aware scheme that advises information related to the NAN cluster to which the printer 10 belongs to external devices. Devices that do not belong to the NAN cluster can join the NAN cluster by receiving the Discovery. That is, the Discovery can be also construed as a signal for inviting devices that do not belong to the NAN cluster to the NAN cluster. The printer 10 periodically sends a Discovery.

At the time of T22, the terminal 100 is in the state of being able to receive signals according to the Wi-Fi Aware scheme, and thus, the terminal 100 receives the Discovery from the printer 10 in T22. In response, the terminal 100 joins the NAN cluster in T24. As a result, the printer 10 and the terminal 100 belong to the same NAN cluster. After joining the NAN cluster, the terminal 100 communicates with the printer 10 to determine its role in the NAN cluster. In the present case, the terminal 100 operates as a Non-Master.

In T26, the terminal 100 sends a Subscribe within the NAN cluster by broadcasting. In the present case, this Subscribe is sent to the printer 10 within the NAN cluster. If there are devices other than the printer 10 and the terminal 100 within the NAN cluster, the Subscribe is also sent to these devices. The Subscribe sent in T26 is a signal for searching for a device that provides the connection service, that is, a signal for searching for a device that can establish a Wi-Fi Aware connection.

In T26, the printer 10 receives the Subscribe from the terminal 100. Since the printer 10 can provide the connection service, the printer 10 sends a Publish to the terminal 100 in T28. This Publish includes a serial number PI of the printer 10.

In T28, the terminal 100 receives the Publish from the printer 10. If there are other devices within the NAN cluster, the terminal 100 may receive Publishes from these devices. In response to receiving one or more Publishes, the terminal 100 causes the display unit 114 to display a selection screen SC1 in T30. The selection screen SCI includes a message that prompts the user to select a desired device for which a Wi-Fi Aware connection is to be established with the terminal 100 and the received one or more serial numbers. In the present case, the selection screen SC1 includes the serial number P1.

In T32, the terminal 100 receives selection of the serial number PI in the selection screen SC1 from the user. In response, a pairing process is executed between the printer 10 corresponding to the selected serial number P1 and the terminal 100 in T34. During the pairing process, the printer 10 and the terminal 100 store pairing information (e.g., an NAN Pairing Key (NPK), an NAN Identity Key (NIK)) for Wi-Fi Aware connection. As a result, in T40, a Wi-Fi Aware connection is established between the printer 10 and the terminal 100 by using the pairing information.

Once the Wi-Fi Aware connection has been established between the printer 10 and the terminal 100, the printer 10 stores the pairing information and a serial number Tl of the terminal 100 in association with each other in the memory 34 in T42.

Once the Wi-Fi Aware connection has been established between the printer 10 and the terminal 100, the terminal 100 stores the pairing information and the serial number Pl in association with each other in the memory 134 in T44.

The printer 10 and the terminal 100 can wirelessly communicate with each other via the AP 6A and can also wirelessly communicate with each other by using the Wi-Fi Aware connection. In this embodiment, the terminal 100 can send print data to the printer 10 by using wireless communication via the AP 6A. The terminal 100 can also receive a status of the printer 10 from the printer 10 by using wireless communication via the Wi-Fi Aware connection. The status of the printer 10 is used when the user wishes the printer 10 to execute printing. In this embodiment, the user wishes the printer 10 for which the Wi-Fi Aware connection has already been established with the terminal 100 to execute printing.

Thereafter, the user installs the AP 6B in place of the AP 6A. The AP connection between the printer 10 and the AP 6A and the AP connection between the terminal 100 and the AP 6A are thereby disconnected. That is, the printer 10 and the terminal 100 are no longer able to wirelessly communicate with each other via the AP 6A. In a modification, the AP connection between the printer 10 and the AP 6A and the AP connection between the terminal 100 and the AP 6A may be disconnected due to the AP 6A being turned off.

After the AP 6B has been installed, a process for establishing an AP connection between the terminal 100 and the AP 6B is executed in T50, and as a result, an AP connection is established between the terminal 100 and the AP 6B. This process includes, for example, input of the SSID “BBB” and the PW “YYY” into the terminal 100, authentication of the input SSID “BBB” and PW “YYY”, etc. At this time, an AP connection is not established between the printer 10 and the newly installed AP 6B, for example, because the user forgets to establish an AP connection therebetween.

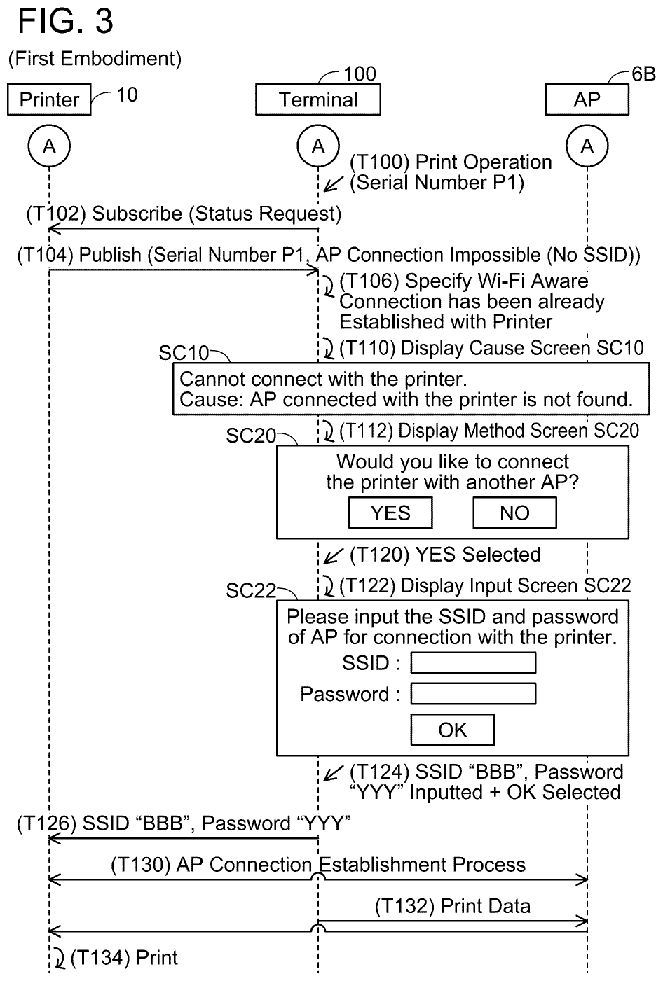

### Continuation From FIG. 2: FIG. 3

In T100 of FIG. 3, the terminal 100 receives a print operation from the user. This print operation includes, for example, selection of the serial number PI of the printer 10 at which printing is to be executed, selection of image data representing a print target image, selection of a print condition (e.g., a paper size, the number of copies, a color condition (color, monochrome, or grayscale), etc.), and the like. In response, the terminal 100 sends a Subscribe within the NAN cluster by broadcasting in T102. This Subscribe is a signal for searching for a device that provides the status service, that is, a signal for requesting a status of a device to which the Subscribe is sent. In the present case, the Subscribe is sent to the printer 10 within the NAN cluster.

In T102, the printer 10 receives the Subscribe from the terminal 100. In response, the printer 10 searches for APs present around the printer 10 (e.g., sends a Probe Request), although this is not illustrated. In the present case, the AP 6B is present around the printer 10, and thus the printer 10 receives the SSID “BBB” from the AP 6B. The printer 10 has never joined a wireless network identified by the SSID “BBB”. In this case, the printer 10 sends a Publish to the terminal 100 by using the already-established Wi-Fi Aware connection between the printer 10 and the terminal 100 in T104. This Publish includes the serial number PI of the printer 10 and AP connection disablement information (SSID Not Found). Here, “AP connection disablement information (SSID Not Found)” means that the printer 10 is unable to establish an AP connection because an SSID of a wireless network that the printer 10 has joined before was not found in the search.

In T104, the terminal 100 receives the Publish from the printer 10. Since the Publish includes the AP connection disablement information (SSID Not Found), the terminal 100 can recognize that the printer 10 has no AP connection established. In this case, the terminal 100 determines in T106 whether the terminal 100 has a Wi-Fi Aware connection established (i.e., has executed pairing) with the device that has sent the Publish (which is the printer 10 in the present case). Specifically, the terminal 100 determines whether the serial number PI included in the received Publish is already stored in association with the pairing information. In the present case, the terminal 100 already stores the serial number PI in association with the pairing information (see T42 in FIG. 2). Thus, in T106, the terminal 100 determines that a Wi-Fi Aware connection is already established with the printer 10.

The determination on whether a Wi-Fi Aware connection is already established with the device that has sent the Publish is made for the following reason. The user probably does not wish printing to be executed at a printer for which a Wi-Fi Aware connection is not established with the terminal 100. Since the user does not wish printing at such a printer, the terminal 100 does not need to be able to wirelessly communicate with the printer via an AP even when it receives a Publish including the AP connection disablement information (SSID Not Found) from such a printer. That is, the printer does not need to establish an AP connection with the AP 6B. Thus, when the terminal 100 determines in T106 that a Wi-Fi Aware connection is not established with the printer that has sent the Publish, a sequence from T110 onward, which is for establishing an alternative communication path for communication of print data, is not executed. By making the determination in T106, the terminal 100 can determine whether the sequence from T110 onward is to be executed or not.

In response to receiving the Publish including the AP connection disablement information (SSID Not Found) in T104 from the printer 10 and determining in T106 that a Wi-Fi Aware connection is already established with the printer 10, the terminal 100 causes the display unit 114 to display a cause screen SC10 in T110. The cause screen SC10 includes a message indicating that wireless communication is inexecutable with the printer 10 via an AP and a message indicating the cause of wireless communication being inexecutable with the printer 10 via an AP (e.g., “AP connected with the printer is not found.”).

In T112, the terminal 100 causes the display unit 114 to display a method screen SC20. The method screen SC20 indicates a method for executing alternative wireless communication instead of wireless communication via the AP 6A and includes a message asking the user whether the printer 10 is to be connected with another AP, a YES button, and NO button. The method screen SC20 allows the user to be notified of the method for causing the printer 10 to execute printing (i.e., that an AP connection needs to be established between the printer 10 and another AP).

In T120, the terminal 100 receives selection of the YES button in the method screen SC20 from the user. In response, the terminal 100 causes the display unit 114 to display an input screen SC22 in T122. The input screen SC22 includes a message that prompts the user to input an SSID and a PW of an AP (in the present case, the AP 6B) for which an AP connection is to be established with the printer 10, an SSID entry field, a PW entry field, and an OK button.

In T124, the terminal 100 receives input of the SSID “BBB” of the AP 6B into the SSID entry field, input of the PW “YYY” of the AP 6B into the PW entry field, and selection of the OK button in the input screen SC22 from the user. In response, the terminal 100 sends the input SSID “BBB” and PW “YYY” to the printer 10 in T126 by using the already-established Wi-Fi Aware connection.

In T126, the printer 10 receives the SSID “BBB” and the PW “YYY” from the terminal 100. In response, a process for establishing an AP connection between the printer 10 and the AP 6B is executed in T130, and as a result, an AP connection is established between the printer 10 and the AP 6B. This process includes, for example, a search for a wireless network identified by the received SSID “BBB” (i.e., a search for the AP 6B), authentication of the received SSID “BBB” and PW “YYY”, etc. Once the AP connection has been established with the AP 6B, the printer 10 stores the SSID “BBB”, although this is not illustrated.

Once the AP connection has been established between the printer 10 and the AP 6B, the printer 10 and the terminal 100 both belong to the wireless network formed by the AP 6B. That is, the printer 10 and the terminal 100 are communicable with each other via the AP 6B. In T132, the terminal 100 sends print data to the printer 10 via the AP 6B. This print data has a data format that the printer 10 can interpret.

In response to receiving the print data from the terminal 100 via the AP 6B in T132, the printer 10 causes the print executing unit 18 to print a print target image represented by the print data in T134. As above, the printer 10 can receive print data from the terminal 100 via the AP 6B and print the print target image by newly establishing an AP connection with the AP 6B after the AP connection with the AP 6A has been disconnected. Especially, the AP connection between the printer 10 and the AP 6B is established during the course of steps starting from the receipt of the print operation from the user, which improves user convenience.

### Advantageous Effects of First Embodiment

According to the above configuration, the printer 10 shifts to the state of being unable to wirelessly communicate with the terminal 100 via the AP 6A in response to the AP connection with the AP 6A being disconnected after both the AP connection with the AP 6A and the Wi-Fi Aware connection with the terminal 100 have been established (see FIG. 2). In this case, the printer 10 sends a Publish including the AP connection disablement information (SSID Not Found) to the terminal 100 by using the Wi-Fi Aware connection (T104 in FIG. 3). In response to receiving the Publish from the printer 10, the terminal 100 causes the display unit 114 to display the cause screen SC10 (T110). This allows the user of the terminal 100 to be notified that wireless communication via the AP is inexecutable between the printer 10 and the terminal 100.

After the AP connection between the printer 10 and the AP 6A has been disconnected, the user usually has to walk up to the printer 10 and directly operate the printer 10 or has to voluntarily access the printer 10 functioning as a web server in order to newly establish an AP connection. In contrast, according to the embodiment above, after the AP connection between the printer 10 and the AP 6A has been disconnected, an AP connection can be newly established between the printer 10 and the AP 6B during the course of steps starting from the receipt of the print operation (T100 to T130 in FIG. 3). This improves user convenience.

### Correspondence Relationships

The printer 10 and the terminal 100 are examples of “communication device” and “terminal device”, respectively. The AP 6A and the AP 6B are examples of “first external device” and “second external device”, respectively. The serial number PI of the printer 10 is an example of “specific identification information”. The normal W-Fi scheme and the Wi-Fi Aware scheme are examples of “first scheme” and “second scheme”, respectively. The AP connection established between the printer 10 and the AP 6A in T10 of FIG. 2 and the AP connection established between the terminal 100 and the AP 6A in T12 of FIG. 2 are examples of “first wireless connection between the communication device and a first external device” and “first wireless connection between the terminal device and the first external device”, respectively. The Wi-Fi Aware connection established between the printer 10 and the terminal 100 in T40 is an example of “second wireless connection”. The AP connection established between the printer 10 and the AP 6B in T130 of FIG. 3 is an example of “third wireless connection”. The Subscribe in T102 is an example of “specific process request”. The AP connection disablement information (SSID Not Found) included in the Publish in T104 is examples of “disablement information”, “cause information”, and “first cause information”. The method screen SC20 is an example of “first method information”. The print data sent in T132 is an example of “corresponding information”. The SSID “BBB” and the PW “YYY” of the AP 6B are an example of “connection information”.

T10 and T40 in FIG. 2 and T130 in FIG. 3 are examples of “establish a first wireless connection”, “establish a second wireless connection”, and “establish a third wireless connection” by the “communication device”, respectively. T104 is an example of “send disablement information” by the “communication device”. T126 and T132 are examples of “receive connection information” and “receive corresponding information that corresponds to the specific process request from the terminal device via the Wi-Fi interface by using the third wireless connection” by the “communication device”, respectively.

T12 and T40 in FIG. 2 are examples of “establish a first wireless connection” and “establish a second wireless connection” by the “terminal device”, respectively. T102 in FIG. 3 is examples of “send a status request” and “send a specific process request” by the “terminal device”. T104 is examples of “receive disablement information” and “receive cause information” by the “terminal device”. T110 and T112 are examples of “cause an output unit of the terminal device to output the disablement information” and “cause the output unit to output method information” by the “terminal device”, respectively. T126 and T132 are examples of “send connection information” and “send corresponding information that corresponds to the specific process request to the communication device via the Wi-Fi interface by using the third wireless connection” by the “terminal device”, respectively.

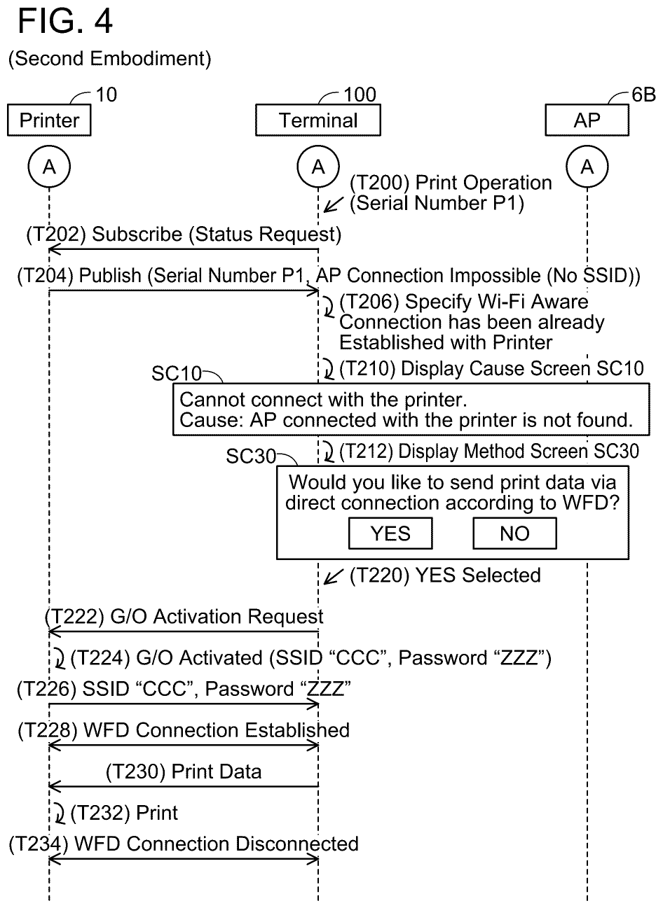

### Second Embodiment: FIG. 4

Referring now to FIG. 4, a second embodiment is described. The second embodiment is different from the first embodiment in the method screen. In the second embodiment, the Wi-Fi I/Fs 16, 116 further support a Wi-Fi Direct (WFD, a registered trademark owned by the Wi-Fi Alliance) scheme of the Wi-Fi standard established by the Wi-Fi Alliance. The WFD scheme is detailed in the specification “Wi-Fi Direct Specification Version 1.9” created by the Wi-Fi Alliance. FIG. 4 shows a sequence continued from FIG. 2. A sequence from T200 to T210 in FIG. 4 is the same as the sequence from T100 to T110 in FIG. 3.

In T212, the terminal 100 causes the display unit 114 to display a method screen SC30. The method screen SC30 indicates a method for executing alternative wireless communication instead of wireless communication via the AP 6A and includes a message asking the user whether a wireless connection according to the WFD scheme (i.e., a direct connection) is to be established between the printer 10 and the terminal 100, a YES button, and a NO button. Hereinafter, a wireless connection according to the WFD scheme is termed a “WFD connection”. The method screen SC30 allows the user to be notified of the method for causing the printer 10 to execute printing (i.e., that a WFD connection needs to be established with the printer 10).

In T220, the terminal 100 receives selection of the YES button in the method screen SC30 from the user. In response, in T222, the terminal 100 sends the printer 10 a G/O activate request that requests the printer 10 to operate as a Group Owner (i.e., as a parent station, termed G/O) of the WFD scheme, by using the already-established Wi-Fi Aware connection between the printer 10 and the terminal 100.

In response to receiving the G/O activate request from the terminal 100 in T222, the printer 10 starts operating as G/O in T224. The printer 10 operating as the G/O forms a wireless network identified by an SSID “CCC”. In this wireless network, a PW “ZZZ” is used. In T226, the printer 10 sends the SSID “CCC” and the PW “ZZZ” to the terminal 100 by using the already-established Wi-Fi Aware connection between the printer 10 and the terminal 100. Then, a process according to the WFD scheme, including Authentication, Association, 4-way handshake, etc., is executed between the printer 10 and the terminal 100, and as a result, a WFD connection is established between the printer 10 and the terminal 100 in T228.

Once the WFD connection has been established between the printer 10 and the terminal 100, the printer 10 and the terminal 100 become communicable with each other. In T230, the terminal 100 sends print data to the printer 10 by using the WFD connection.

In response to receiving the print data from the terminal 100 in T230, the printer 10 causes the print executing unit 18 to print a print target image represented by the print data in T232. As above, the printer 10 can receive print data from the terminal 100 and print the print target image by newly establishing a WFD connection with the terminal 100 after the AP connection with the AP 6A has been disconnected. Especially, the WFD connection between the printer 10 and the terminal 100 is established during the course of steps starting from the receipt of the print operation from the user, which improves user convenience. After the printing has been completed, the WFD connection between the printer 10 and the terminal 100 is disconnected. In this embodiment, the terminal 100 is an example of “second external device”. The G/O activate request in T222 of FIG. 4 is an example of “predetermined request”. The WFD connection established in T228 is an example of “third wireless connection”. T222 in FIG. 4 is an example of “receive a predetermined request” by the “communication device” and an example of “send a predetermined request” by the “terminal device”.

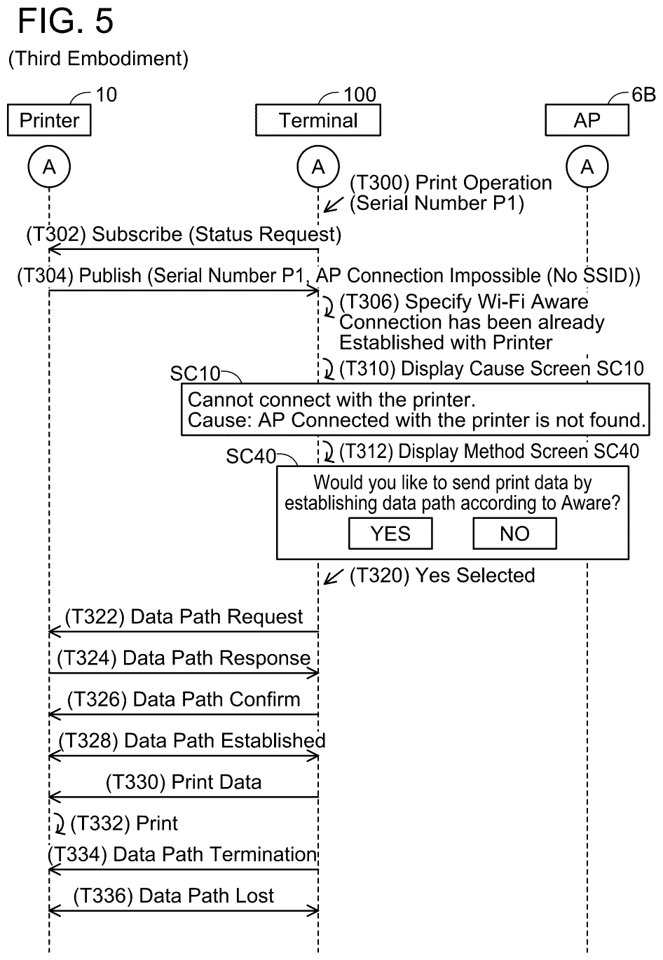

### Third Embodiment: FIG. 5

Referring now to FIG. 5, a third embodiment is described. The third embodiment is different from the first and second embodiments in the method screen. FIG. 5 shows a sequence continued from FIG. 2. A sequence from T300 to T310 in FIG. 5 is the same as the sequence from T100 to T110 in FIG. 3.

In T312, the terminal 100 causes the display unit 114 to display a method screen SC40. The method screen SC40 indicates a method for executing alternative wireless communication instead of wireless communication via the AP 6A and includes a message asking the user whether print data is to be communicated by using the already-established Wi-Fi Aware connection between the printer 10 and the terminal 100, a YES button, and a NO button. The method screen SC40 allows the user to be notified of the method for causing the printer 10 to execute printing (i.e., that the already-established Wi-Fi Aware connection needs to be used).

In T320, the terminal 100 receives selection of the YES button in the method screen SC40 from the user. In response, the terminal 100 sends a Data Path Request to the printer 10 in T322. The Data Path Request is a signal that requests the printer 10 to establish a communication path (i.e., a Data Path) for communication of print data in the already-established Wi-Fi Aware connection (see T40 in FIG. 2).

In response to receiving the Data Path Request from the terminal 100 in T322, the printer 10 sends a Data Path Response to the terminal 100 in T324.

In response to receiving the Data Path Response from the printer 10 in T324, the terminal 100 sends a Data Path Confirm to the printer 10 in T326. As a result, a Data Path is established in the Wi-Fi Aware connection between the printer 10 and the terminal 100 in T328. Then, the terminal 100 sends print data representing a print target image to the printer 10 by using the Data Path in T330.

In response to receiving the print data from the terminal 100 in T330, the printer 10 causes the print executing unit 18 to print the print target image represented by the print data in T332. As above, the printer 10 can receive print data from the terminal 100 and print the print target image by establishing a Data Path in the already-established Wi-Fi Aware connection after the AP connection with the AP 6A has been disconnected. Especially, the Data Path is established during the course of steps starting from the receipt of the print operation from the user, which improves user convenience.

After having sent the print data in T330, the terminal 100 sends a Data Path Termination to the printer 10 in T334. As a result, the Data Path between the printer 10 and the terminal 100 disappears in T336. In this embodiment, T330 in FIG. 5 is an example of “receive corresponding information that corresponds to the specific process request from the terminal device via the Wi-Fi interface by using the second wireless connection” by the “communication device” and an example of “send corresponding information that corresponds to the specific process request to the communication device via the Wi-Fi interface by using the second wireless connection” by the “terminal device”.

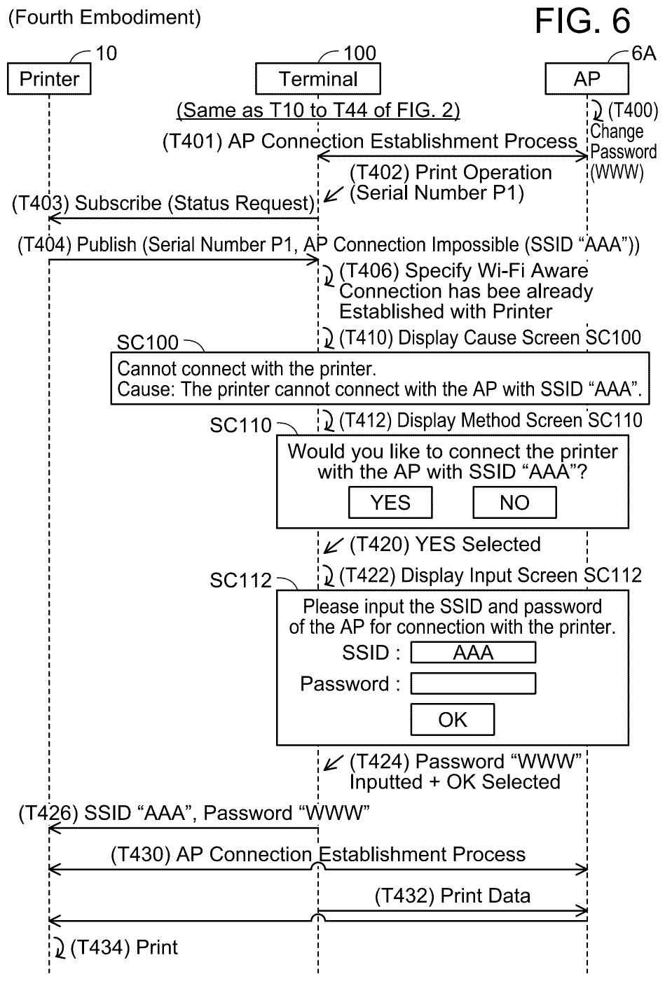

### Fourth Embodiment: FIG. 6

Referring now to FIG. 6, a fourth embodiment is described. The fourth embodiment is different from the first embodiment in the cause of the printer 10 not being able to establish an AP connection with the AP 6A. In FIG. 6, first, the same sequence as the sequence from T10 to T44 in FIG. 2 is executed. That is, the printer 10 and the terminal 100 both join the wireless network formed by the AP 6A and a Wi-Fi Aware connection is established between the printer 10 and the terminal 100.

In T400, the PW “XXX” of the AP 6A is changed to a PW “WWW”. Thereby, the AP connections between the AP 6A and each of the printer 10 and the terminal 100 are disconnected.

In T401, a process for reestablishing an AP connection between the terminal 100 and the AP 6A with the changed PW is executed, and as a result, an AP connection is reestablished between the terminal 100 and the AP 6A. The above process includes, for example, input of the SSID “AAA” and the changed PW “WWW” into the terminal 100, authentication of the input SSID “AAA” and PW “WWW”, etc. T402 and T403 are the same as T100 and T102 in FIG. 3.

In T403, the printer 10 receives a Subscribe from the terminal 100. In response, the printer 10 executes a process to search for APs present around the printer 10 and receives the SSID “AAA” from the AP 6A, although this is not illustrated. The printer 10 has joined the wireless network identified by the SSID “AAA” before. In this case, the printer 10 sends a Publish to the terminal 100 by using the already-established Wi-Fi Aware connection between the printer 10 and the terminal 100 in T404. This Publish includes the serial number P1 of the printer 10 and AP connection disablement information (SSID “AAA”). Here, the AP connection disablement information (SSID “AAA”) means that the SSID “AAA” of the wireless network that the printer 10 has joined before was found in the search. T406 is the same as T106 in FIG. 3.

In response to receiving the Publish including the AP connection disablement information (SSID “AAA”) from the printer 10 in T404 and determining in T406 that a Wi-Fi Aware connection is already established with the printer 10, the terminal 100 causes the display unit 114 to display a cause screen SC100 in T410. The cause screen SC100 includes a message indicating that wireless communication is inexecutable via an AP with the printer 10 and a message indicating the cause of wireless communication being inexecutable via an AP with the printer 10 (e.g., “The printer cannot connect with the AP with the SSID “AAA”).

In T412, the terminal 100 causes the display unit 114 to display a method screen SC110. The method screen SC110 indicates a method for executing alternative wireless communication instead of wireless communication via the AP 6A with which the AP connection was disconnected, and includes a message asking the user whether the printer 10 is to be reconnected with the same AP 6A, a YES button, and a NO button. Thus, the method screen SC110 displayed here is different from the method screen SC20 (see T112 in FIG. 3) displayed in response to the receipt of the AP connection disablement information (SSID Not Found) in the first embodiment. Thus, the terminal 100 can display different method screens depending on the cause of wireless communication being inexecutable via an AP with the printer 10.

In T420, the terminal 100 receives selection of the YES button in the method screen SC110 from the user. In response, the terminal 100 causes the display unit 114 to display an input screen SC112. The input screen SC112 is the same as the input screen SC22 (see FIG. 3) except that the SSID “AAA” is shown in the SSID entry field.

In T424, the terminal 100 receives input of the changed PW “WWW” of the AP 6A into the PW entry field in the input screen SC112 and selection of the OK button from the user. In response, the terminal 100 sends the SSID “AAA” shown in the input screen SC112 and the input PW “WWW” to the printer 10 by using the already-established Wi-Fi Aware connection in T426.

In T426, the printer 10 receives the SSID “AAA” and the PW “WWW” from the terminal 100. In response, a process for establishing an AP connection between the printer 10 and the AP 6A is executed in T430, and as a result, an AP connection is reestablished between the printer 10 and the AP 6A. The above process includes, for example, a search for the wireless network identified by the received SSID “AAA” (i.e., a search for the AP 6A), authentication of the received SSID “AAA” and PW “WWW”, etc. T432 and T434 are the same as T132 and T134 in FIG. 3 except for using the wireless network formed by the AP 6A instead of the wireless network formed by the AP 6B. In this embodiment, the AP connection disablement information (SSID “AAA”) included in the Publish in T404 of FIG. 6 is an example of “second cause information”. The method screen SC110 is an example of “second method information”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(Modification 1) In the above embodiments, the AP connection between the printer 10 and the AP 6A is disconnected after the printer 10 and the terminal 100 have joined the wireless network formed by the AP 6A. In a modification, the technology is useful even where a WFD connection is disconnected after the WFD connection has been established between the printer 10 and the terminal 100. A WFD connection may be disconnected, for example, when the number of child stations allowed to establish a WFD connection reaches its upper limit. For example, a situation is assumed where the upper limit for the number of child stations allowed to establish a WFD connect is three and three WFD connections are already established between the printer 10 operating as G/O and three devices (i.e., child stations) including the terminal 100. When a WFD connection is to be established between the printer 10 and a device other than the three devices in that situation, a WFD connection between the printer 10 and one of the three devices may be disconnected. In this modification, the terminal 100 is an example of “first external device”, the WFD scheme is an example of “first scheme”, and the WFD connection is an example of “first wireless connection”.

(Modification 2) The terminal 100 may send a Subscribe to devices within the NAN cluster to request their statuses, for example, in response to receiving a status request operation for requesting statuses of printers within the NAN cluster after the AP connection between the printer 10 and the AP 6A has been disconnected (see T102 in FIG. 3). Then, the printer 10 may send its status to the terminal 100 via the AP 6B after an AP connection with the AP 6B has been established. In this modification, the above Subscribe is an example of “specific process request” and the status sent from the printer 10 to the terminal 100 via the AP 6B is an example of “corresponding information”. The Subscribe sent in T102 of FIG. 3 may not be a signal that requests statuses of devices to which the Subscribe is sent and may be, for example, a signal that requests a specific function to be executed. In this modification, “send a status request” by the “terminal device” may be omitted.

(Modification 3) In the third embodiment described above, a Data Path is established in response to the user selecting the YES button in the method screen SC40 in T320 of FIG. 5. In a modification, a Data Path may be established, for example, when a Wi-Fi Aware connection is established between the printer 10 and the terminal 100. Then, the terminal 100 may send print data to the printer 10 by using the Data Path.

(Modification 4) The wireless connection established between the printer 10 and the terminal 100 in T40 of FIG. 2 may not be a Wi-Fi Aware connection (i.e., a wireless connection according to the Wi-Fi Aware scheme). Generally, the “second scheme” may not be the “Wi-Fi Aware scheme”.

(Modification 5) In T110 of FIG. 3, the terminal 100 may send, for example, an e-mail including the messages included in the cause screen SC10 to a preset administrator's e-mail address. In this modification, sending the e-mail is an example of “cause an output unit of the terminal device to output the disablement information” by the “terminal device”. Similarly, in T112, the terminal 100 may send an e-mail including the message included in the method screen SC20 to the administrator's e-mail address. In this modification, sending the e-mail is an example of “cause the output unit to output method information” by the “terminal device”.

(Modification 6) The terminal 100 may omit T106 in FIG. 3. That is, in response to receiving a Publish including the serial number P1 and the AP connection disablement information (SSID Not Found) from the printer 10 in T104, the terminal 100 may execute the sequence from T110 onward regardless of whether a Wi-Fi Aware connection is already established with the printer 10 or not. In another modification, the terminal 100 may store a MAC address of the printer 10 and the pairing information in association with each other in T44 of FIG. 2. Then, the printer 10 may send a Publish including the MAC address of the printer 10 instead of the serial number P1 to the terminal 100 in T104 of FIG. 3. The terminal 100 then may execute the sequence from T110 onward in response to determining that the MAC address included in the Publish is stored in association with the pairing information. In this modification, the MAC address of the printer 10 is an example of “specific identification information”.

(Modification 7) The terminal 100 may omit T112 in FIG. 3. In this case, for example, the user of the terminal 100 who is familiar with wireless communication settings, etc. may cause a process for establishing an AP connection between the printer 10 and the AP 6B to be executed after viewing the cause screen SC10. In this modification, “cause the output unit to output method information” by the “terminal device” may be omitted.

(Modification 8) The printer 10 may send a Publish that only includes the AP connection disablement information (i.e., does not include the cause (SSID Not Found)) instead of the AP connection disablement information (SSID Not Found). Generally, the “terminal device” may not receive the “cause information”. In this modification, “receive cause information” may be omitted.

(Modification 9) In the embodiments described above, the printer sends a Publish including the AP connection disablement information (SSID Not Found) to the terminal 100 in T104 of FIG. 3. That is, in the embodiments, the “disablement information” and the “cause information” are sent simultaneously. In a modification, they may be sent at different timings. For example, the printer 10 may first send a Publish including the AP connection disablement information to the terminal 100 in T104 of FIG. 3 and then send a Follow-up including the cause of an AP connection being unable to be established (e.g., SSID Not Found) to the terminal 100. This Follow-up is defined by the Wi-Fi Aware scheme. In this modification, receiving the Publish and receiving the Follow-up are examples of “receive disablement information” and “receive cause information” by the “terminal device”, respectively.

(Modification 10) In the embodiments described above, the steps in FIGS. 2 to 6 each are implemented by software (e.g., the program 36, the OS 136, the app 138), however, at least one of these steps may be implemented by hardware such as a logic circuit, etc.

What is claimed is:

1. A communication device comprising:
a Wi-Fi interface configured for wireless communication according to Wi-Fi standard; and
a controller,
wherein the controller is configured to:
establish a first wireless connection between the communication device and a first external device via the Wi-Fi interface according to a first scheme of the Wi-Fi standard, wherein the communication device is able to execute wireless communication with a terminal device by using the first wireless connection;
establish a second wireless connection between the communication device and the terminal device via the Wi-Fi interface according to a second scheme of the Wi-Fi standard different from the first scheme; and
in a case where the communication device shifts to a state in which the communication device is unable to execute wireless communication with the terminal device by using the first wireless connection after both the first wireless connection and the second wireless connection have been established at the communication device, send disablement information to the terminal device via the Wi-Fi interface by using the second wireless connection, wherein the disablement information indicates that the wireless communication using the first wireless connection is inexecutable.

2. The communication device as in claim 1,
wherein the controller is further configured to:
establish a third wireless connection between the communication device and a second external device different from the first external device via the Wi-Fi interface after the disablement information has been sent to the terminal device, wherein the communication device is able to execute wireless communication with the terminal device by using the third wireless connection.

3. The communication device as in claim 2,
wherein the controller is configured to send the disablement information to the terminal device in a case where a specific process request is received from the terminal device via the Wi-Fi interface by using the second wireless connection after the communication device has shifted to the state in which the communication device is unable to execute wireless communication with the terminal device by using the first wireless connection,
wherein the controller is further configured to:
after the third wireless connection has been established, receive corresponding information that corresponds to the specific process request from the terminal device via the Wi-Fi interface by using the third wireless connection.

4. The communication device as in claim 2,
wherein the controller is further configured to:
after the disablement information has been sent to the terminal device, receive connection information from the terminal device via the Wi-Fi interface by using the second wireless connection,
wherein the controller is configured to establish the third wireless connection between the communication device and the second external device which is an access point by using the connection information.

5. The communication device as in claim 2,
wherein the controller is further configured to:
after the disablement information has been sent to the terminal device, receive a predetermined request according to a Wi-Fi Direct scheme of the Wi-Fi standard from the terminal device via the Wi-Fi interface by using the second wireless connection,
wherein in a case where the predetermined request is received from the terminal device, the controller is configured to establish the third wireless connection between the communication device and the second external device which is the terminal device according to the Wi-Fi Direct scheme.

6. The communication device as in claim 1,
wherein the controller is configured to send the disablement information to the terminal device in a case where a specific process request is received from the terminal device via the Wi-Fi interface by using the second wireless connection after the communication device has shifted to the state in which the communication device is unable to execute wireless communication with the terminal device by using the first wireless connection,
wherein the controller is further configured to:
in a case where the disablement information is sent to the terminal device, receive corresponding information that corresponds to the specific process request from the terminal device via the Wi-Fi interface by using the second wireless connection.

7. The communication device as in claim 1,
wherein the first scheme is a Wi-Fi scheme for executing wireless communication via an access point or a Wi-Fi Direct scheme, and
the second scheme is a Wi-Fi Aware scheme.

8. A terminal device comprising:
a Wi-Fi interface configured for wireless communication according to Wi-Fi standard; and
a controller,
wherein the controller is configured to:
establish a first wireless connection between the terminal device and a first external device via the Wi-Fi interface according to a first scheme of the Wi-Fi standard, wherein the terminal device is able to execute wireless communication with a communication device by using the first wireless connection;
establish a second wireless connection between the communication device and the terminal device via the Wi-Fi interface according to a second scheme of the Wi-Fi standard different from the first scheme;
in a case where the communication device shifts to a state in which the communication device is unable to execute wireless communication with the terminal device by using the first wireless connection after both the first wireless connection and the second wireless connection have been established at the terminal device, receive disablement information from the communication device via the Wi-Fi interface by using the second wireless connection, wherein the disablement information indicates that the wireless communication using the first wireless connection is inexecutable; and
in a case where the disablement information is received from the communication device, cause an output unit of the terminal device to output the disablement information.

9. The terminal device as in claim 8,
wherein the controller is further configured to:
send a status request to the communication device via the Wi-Fi interface by using the second wireless connection,
wherein the controller is configured to receive the disablement information from the communication device as a response to the status request.

10. The terminal device as in claim 8, further comprising a memory configured to store one or more identification information for identifying one or more communication devices,
wherein the controller is configured to receive the disablement information and specific identification information for identifying the communication device from the communication device by using the second wireless connection, and
in a case where the received specific identification information is in the memory, the controller is configured to cause the output unit to output the disablement information.

11. The terminal device as in claim 8,
wherein the controller is further configured to:
in a case where the disablement information is received from the communication device, cause the output unit to output method information that indicates a method for executing wireless communication between the terminal device and the communication device without using the first wireless connection.

12. The terminal device as in claim 11,
wherein the controller is further configured to:
in the case where the communication device shifts to the state in which the communication device is unable to execute wireless communication with the terminal device by using the first wireless connection after both the first wireless connection and the second wireless connection have been established at the terminal device, receive cause information from the communication device via the Wi-Fi interface by using the second wireless connection, wherein the cause information indicates a cause of the wireless communication using the first wireless connection being inexecutable;
wherein in a case where the disablement information and first cause information are received from the communication device, the controller is configured to cause the output unit to output first method information, and
in a case where the disablement information and second cause information different from the first cause information are received from the communication device, the controller is configured to cause the output unit to output second method information different from the first method information.

13. The terminal device as in claim 11,
wherein the method information indicates a method for establishing a third wireless connection instead of the first wireless connection between the communication device and a second external device different from the first external device, wherein the terminal device is able to execute wireless communication with the communication device by using the third wireless connection.

14. The terminal device as in claim 13,
wherein the controller is further configured to:
send a specific process request to the communication device via the Wi-Fi interface by using the second wireless connection after the communication device has shifted to the state in which the communication device is unable to execute wireless communication with the terminal device by using the first wireless connection; and
send corresponding information that corresponds to the specific process request to the communication device via the Wi-Fi interface by using the third wireless connection after the third wireless connection has been established between the communication device and the second external device.

15. The terminal device as in claim 13,
wherein the controller is further configured to:
send connection information to the communication device via the Wi-Fi interface by using the second wireless connection after the disablement information has been received from the communication device,
wherein the communication device establishes the third wireless connection between the communication device and the second external device which is an access point by using the connection information.

16. The terminal device as in claim 8,
wherein the controller is further configured to:
in a case where the disablement information is received from the communication device, send a predetermined request according to a Wi-Fi Direct scheme of the Wi-Fi standard to the communication device via the Wi-Fi interface by using the second wireless connection; and
in a case where the predetermined request is sent to the communication device, establish a third wireless connection according to the Wi-Fi Direct scheme between the communication device and the terminal device.

17. The terminal device as in claim 8,
wherein the controller is further configured to:
send a specific process request to the communication device via the Wi-Fi interface by using the second wireless connection after the communication device has shifted to the state in which the communication device is unable to execute wireless communication with the terminal device by using the first wireless connection; and
in a case where the disablement information is received from the communication device, send corresponding information that corresponds to the specific process request to the communication device via the Wi-Fi interface by using the second wireless connection.

18. A non-transitory computer-readable recording medium storing computer-readable instructions for a communication device,
wherein the communication device comprises:
a Wi-Fi interface configured for wireless communication according to Wi-Fi standard; and
a processor,
wherein the computer-readable instructions, when executed by the processor, cause the communication device to:
establish a first wireless connection between the communication device and a first external device via the Wi-Fi interface according to a first scheme of the Wi-Fi standard, wherein the communication device is able to execute wireless communication with a terminal device by using the first wireless connection;
establish a second wireless connection between the communication device and the terminal device via the Wi-Fi interface according to a second scheme of the Wi-Fi standard different from the first scheme; and
in a case where the communication device shifts to a state in which the communication device is unable to execute wireless communication with the terminal device by using the first wireless connection after both the first wireless connection and the second wireless connection have been established at the communication device, send disablement information to the terminal device via the Wi-Fi interface by using the second wireless connection, wherein the disablement information indicates that the wireless communication using the first wireless connection is inexecutable.

19. A non-transitory computer-readable recording medium storing computer-readable instructions for a terminal device,
wherein the terminal device comprises:
a Wi-Fi interface configured for wireless communication according to Wi-Fi standard; and
a processor,
wherein the computer-readable instructions, when executed by the processor, cause the terminal device to:
establish a first wireless connection between the terminal device and a first external device via the Wi-Fi interface according to a first scheme of the Wi-Fi standard, wherein the terminal device is able to execute wireless communication with a communication device by using the first wireless connection;
establish a second wireless connection between the communication device and the terminal device via the Wi-Fi interface according to a second scheme of the Wi-Fi standard different from the first scheme;
in a case where the communication device shifts to a state in which the communication device is unable to execute wireless communication with the terminal device by using the first wireless connection after both the first wireless connection and the second wireless connection have been established at the terminal device, receive disablement information from the communication device via the Wi-Fi interface by using the second wireless connection, wherein the disablement information indicates that the wireless communication using the first wireless connection is inexecutable; and
in a case where the disablement information is received from the communication device, cause an output unit of the terminal device to output the disablement information.
